(19) United States
(12) Patent Application Publication
(10) Pub. No.: US 2018/0244140 A1
(43) Pub. Date: Aug. 30, 2018

(54) Vehicle Opening Covering Assembly

(71) Applicant: James Thacker, Hampton, VA (US)

(72) Inventor: James Thacker, Hampton, VA (US)

(21) Appl. No.: 15/442,076

(22) Filed: Feb. 24, 2017

(51) Int. Cl. B60J 11/08

(52) U.S. Cl. CPC B60J 11/08

(57) ABSTRACT

A vehicle opening covering assembly for recreational vehicles includes a panel that is flexible. The panel is substantially rectangularly shaped and water resistant. The panel is configured to couple to a recreational vehicle such that panel is configured to cover an opening, such as a window, of the recreational vehicle.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention.

### (2) Description of Related Art Including Information Disclosed Under 37 CFR 1.97 and 1.98

The disclosure and prior art relates to covering assemblies and more particularly pertains to a new covering assembly for recreational vehicles.

### BRIEF SUMMARY OF THE INVENTION

An embodiment of the disclosure meets the needs presented above by generally comprising a panel that is flexible. The panel is substantially rectangularly shaped and water resistant. The panel is configured to couple to a recreational vehicle such that panel is configured to cover an opening, such as a window, of the recreational vehicle.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of a vehicle opening covering assembly according to an embodiment of the disclosure.

FIG. 2 is a back view of an embodiment of the disclosure.

FIG. 3 is an in-use view of an embodiment of the disclosure.

FIG. 4 is a back view of an embodiment of the disclosure.

### DETAILED DESCRIPTION OF THE INVENTION

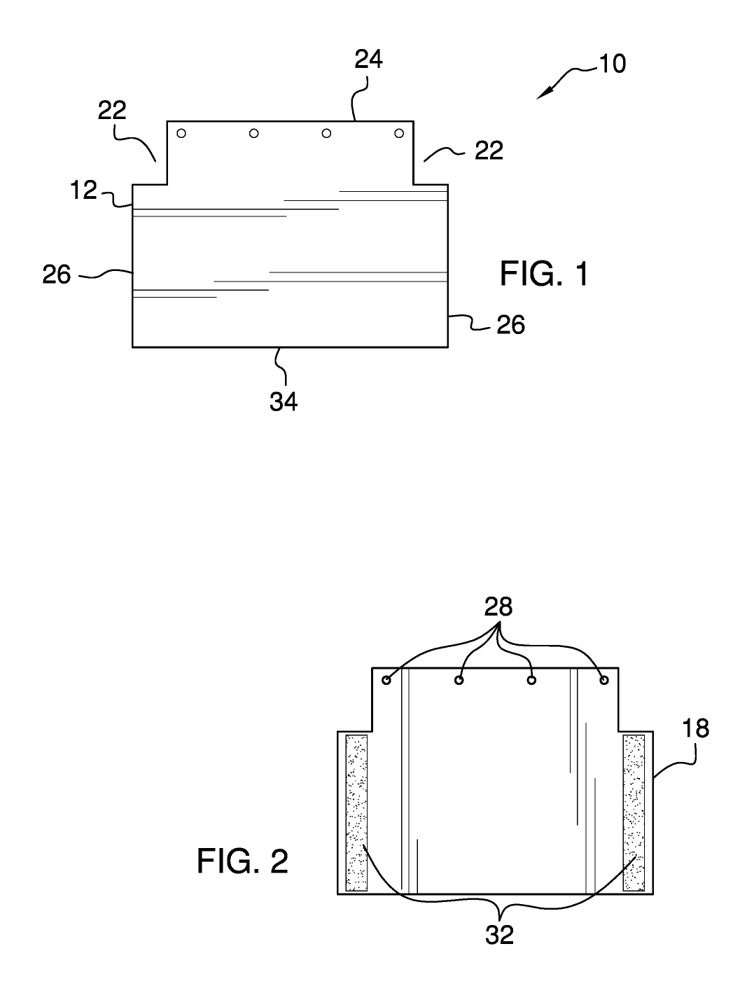

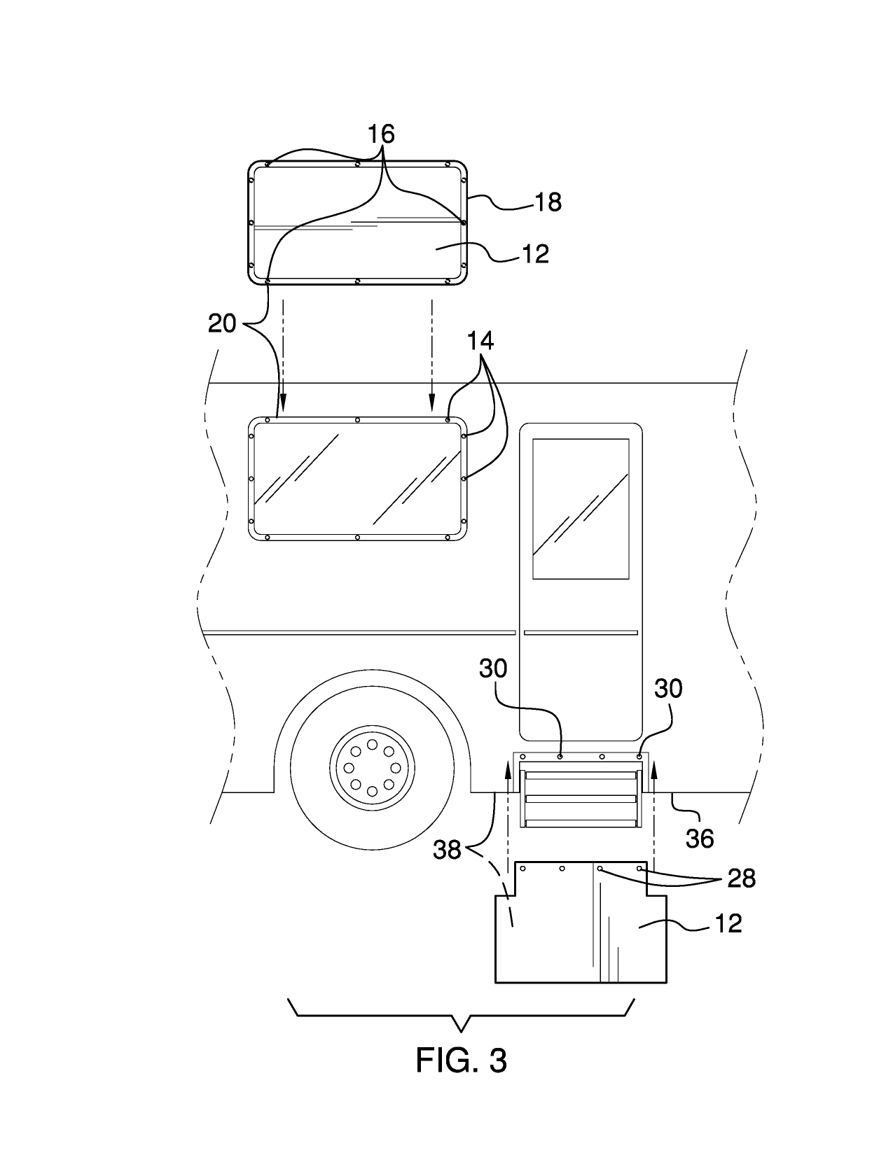

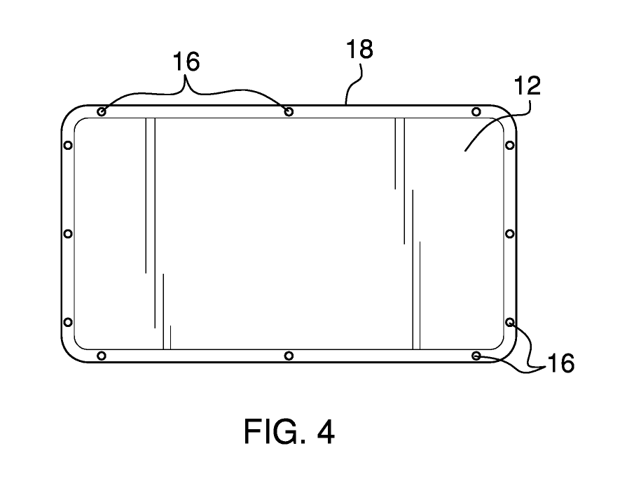

With reference now to the drawings, and in particular to FIGS. 1 through 4 thereof, a new covering assembly embodying the principles and concepts of an embodiment of the disclosure and generally designated by the reference numeral 10 will be described.

As best illustrated in FIGS. 1 through 4, the vehicle opening covering assembly 10 generally comprises a panel 12 that is flexible. The panel 12 is substantially rectangularly shaped and water resistant. The panel 12 is configured to couple to a recreational vehicle. The panel 12 is configured to cover an opening, such as a window, of the recreational vehicle. In one embodiment, the panel 12 comprises vinyl.

A plurality of first couplers 14 is coupled to the recreational vehicle proximate to a circumference of the opening. A plurality of second couplers 16 is coupled to the panel 12 proximate to a perimeter 18 of the panel 12. The second couplers 16 are complementary to the first couplers 14. Each second coupler 16 is positioned to couple to a respective first coupler 14 to couple the panel 12 to the recreational vehicle to cover the opening. In one embodiment, each second coupler 16 and the respective first coupler 14 comprise a connector 20 selected from the group consisting of hook and loop fasteners, press stud fasteners, and twist stud fasteners.

In another embodiment, each of a pair of cutouts 22 is positioned in the panel 12 adjacent to a top 24 and a respective opposing side 26 of the panel 12. The cutouts 22 are positioned in the panel 12 so that the panel 12 is configured to cover the opening that comprises a recess in the recreational vehicle. The recess houses the stowed steps of the recreational vehicle. The panel 12 is configured to shield the steps as the recreational vehicle is in transit. In yet another embodiment, the cutouts 22 are substantially rectangularly shaped.

A plurality of female snap pieces 28 is positioned proximate to the top 24 of the panel 12 between the pair of cutouts 22. Each female snap piece 28 is positioned to couple to an associated male snap piece 30 that is coupled to the recreational vehicle proximate to the recess that houses the stowed steps. Each of a pair of first fasteners 32 is positioned on the panel 12 proximate to the respective opposing side 26. The first fastener 32 extends from proximate to an associated cutout 22 to proximate to a bottom 34 of the panel 12. Each first fastener 32 is positioned is positioned to couple to an associated second fastener 36 that is coupled to an underside of the recreational vehicle proximate to the recess that houses the stowed steps. In one embodiment, the plurality of female snap pieces 28 comprises four female snap pieces 28. In another embodiment, each first fastener 32 and the associated second fastener 36 comprise a hook and loop closure 38.

In use, each second coupler 16 is positioned to couple to a respective first coupler 14 to couple the panel 12 to the recreational vehicle to cover the opening, such as the window, of the recreational vehicle. The cutouts 22 are positioned in the panel 12 so that the panel 12 is configured to cover the recess in the recreational vehicle that houses the stowed steps. Each female snap piece 28 is positioned to couple to the associated male snap piece 30. Each first fastener 32 is positioned to couple to the associated second fastener 36. The panel 12 is configured to cover the recess that houses the stowed steps. The panel 12 is configured to shield the steps as the recreational vehicle is in transit.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A vehicle opening covering assembly comprising:
a panel, said panel being flexible, said panel being substantially rectangularly shaped, said panel being water resistant, said panel being configured for coupling to a recreational vehicle; and
wherein said panel is configured for coupling to the recreational vehicle such that said panel is configured for covering an opening, such as a window, of the recreational vehicle.

2. The assembly of claim 1, further including said panel comprising vinyl.

3. The assembly of claim 1, further including a pair of cutouts, each said cutout being positioned in said panel adjacent to a top and a respective opposing side of said panel, wherein said cutouts are positioned in said panel such that said panel is configured for covering the opening comprising a recess in the recreational vehicle that houses the stowed steps of the recreational vehicle, such that said panel is configured for shielding the steps as the recreational vehicle is in transit.

4. The assembly of claim 3, further including said cutouts being substantially rectangularly shaped.

5. The assembly of claim 1, further comprising:
a plurality of first couplers coupled to the recreational vehicle proximate to a circumference of the opening;
a plurality of second couplers coupled to said panel proximate to a perimeter of said panel, said second couplers being complementary to said first couplers; and
wherein each said second coupler is positioned on said panel such that said second coupler is positioned to couple to a respective said first coupler to couple said panel to the recreational vehicle to cover the opening.

6. The assembly of claim 1, further including each said second coupler and said respective said first coupler comprising a connector selected from the group of connectors consisting of hook and loop fasteners, press stud fasteners, and twist stud fasteners.

7. The assembly of claim 3, further comprising:
a plurality of female snap pieces positioned proximate to said top of said panel between said pair of cutouts;
a pair of first fasteners, each said first fastener being positioned on said panel proximate to said respective said opposing side, said first fastener extending from proximate to an associated said cutout to proximate to a bottom of said panel; and
wherein each said female snap piece is positioned on said panel such that said female snap piece is positioned for coupling to an associated male snap piece coupled to the recreational vehicle proximate to the recess that houses the stowed steps, wherein each said first fastener is positioned on said panel such that said first fastener is positioned for coupling to an associated second fastener coupled to an underside of the recreational vehicle proximate to the recess that houses the stowed steps.

8. The assembly of claim 7, further including said plurality of female snap pieces comprising four said female snap pieces.

9. The assembly of claim 7, further including each said first fastener and said associated said second fastener comprising a hook and loop closure.

10. A vehicle opening covering assembly comprising:
a panel, said panel being flexible, said panel being substantially rectangularly shaped, said panel being water resistant, said panel being configured for coupling to a recreational vehicle, wherein said panel is configured for coupling to the recreational vehicle such that said panel is configured for covering an opening, such as a window, of the recreational vehicle, said panel comprising vinyl;
a pair of cutouts, each said cutout being positioned in said panel adjacent to a top and a respective opposing side of said panel, wherein said cutouts are positioned in said panel such that said panel is configured for covering the opening comprising a recess in the recreational vehicle that houses the stowed steps of the recreational vehicle, such that said panel is configured for shielding the steps as the recreational vehicle is in transit, said cutouts being substantially rectangularly shaped;
a plurality of first couplers coupled to the recreational vehicle proximate to a circumference of the opening;
a plurality of second couplers coupled to said panel proximate to a perimeter of said panel, said second couplers being complementary to said first couplers, wherein each said second coupler is positioned on said panel such that said second coupler is positioned to couple to a respective said first coupler to couple said panel to the recreational vehicle to cover the opening, each said second coupler and said respective said first coupler comprising a connector selected from the group consisting of hook and loop fasteners, press stud fasteners, and twist stud fasteners;
a plurality of female snap pieces positioned proximate to said top of said panel between said pair of cutouts, wherein each said female snap piece is positioned on said panel such that said female snap piece is positioned for coupling to an associated male snap piece coupled to the recreational vehicle proximate to the recess that houses the stowed steps, said plurality of female snap pieces comprising four said female snap pieces;
a pair of first fasteners, each said first fastener being positioned on said panel proximate to said respective said opposing side, said first fastener extending from proximate to an associated said cutout to proximate to a bottom of said panel, wherein each said first fastener is positioned on said panel such that said first fastener is positioned for coupling to an associated said second fastener coupled to an underside of the recreational vehicle proximate to the recess that houses the stowed steps, each said first fastener and said associated said second fastener comprising a hook and loop closure; and
wherein each said second coupler is positioned on said panel such that said second coupler is positioned to couple to a respective said first coupler to couple said panel to the recreational vehicle to cover the opening, such as the window, of the recreational vehicle, wherein said cutouts are positioned in said panel such that said panel is configured for covering the recess in the recreational vehicle that houses the stowed steps, wherein each said female snap piece is positioned on said panel such that said female snap piece is positioned for coupling to said associated said male snap piece, wherein each said first fastener is positioned for coupling to said associated said second fastener such that said panel is configured for covering the recess that houses the stowed steps, such that said panel is configured for shielding the steps as the recreational vehicle is in transit.
